(19) United States
(12) Patent Application Publication
(10) Pub. No.: US 2008/0068253 A1
(43) Pub. Date: Mar. 20, 2008

(54) Simulcasting content information on WiFi to extend a value chain

(76) Inventors: Pratik M. Mehta, Austin, TX (US); Neeraj Srivastava, Austin, TX (US)

Correspondence Address: HAMILTON & TERRILE, LLP, P.O. BOX 203518, AUSTIN, TX, 78720, US

(21) Appl. No.: 11/533,068

(22) Filed: Sep. 19, 2006

(51) Int. Cl. G01S 13/58

(52) U.S. Cl. 342/115

(57) ABSTRACT

A system and method is disclosed for enabling an extended value chain that facilitates the on-line purchase of a copy of digitized audio and/or video content by decoupling and simulcasting metadata from the content as it is played. One or more digitized audio/video content streams containing metadata are intercepted prior to being played. Associated metadata within the intercepted content stream is identified, decoupled, supplemented, and wirelessly simulcasted. The simulcasted metadata is automatically received and enacted upon by similarly enabled wireless devices to facilitate the on-line purchase of a copy of the associated content, in electronic or physical form, at the present or a later time. Simulcasted metadata is presented to predetermined on-line content providers to initiate a purchase transaction and contains information identifying stakeholders in an extended value chain who will receive a proportionate share of each on-line content sale they facilitate. Audio content metadata received via satellite radio is similarly intercepted by a mobile metadata simulcaster and locally simulcast via a wireless protocol such as, but not limited to, Bluetooth to similarly enabled wireless devices to facilitate on-line purchases of audio content through a wireless wide area network connection to the Internet.

### BACKGROUND OF THE INVENTION

1. Field of the Invention

The present invention relates in general to the field of digitized content delivery and more specifically, to providing simulcast metadata to enable an extended value chain that facilitates its purchase.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The delivery of digitized audio/video (A/V) content to a variety of information handling systems has become commonplace. In the past, collateral information about A/V content, including the publisher, artist, track length, lyrics, and so forth, was generally provided in the form of printed inserts (e.g., such as liner notes), or on the content's physical packaging itself. With the growing acceptance of digital delivery, the concept of incorporating metadata (i.e., data about the data) with digitized content is now standard practice. For example, compact disks (CDs) include a unique identification code that can be referenced to retrieve metadata from databases (e.g., compact disk database, or CDDB) that are accessible through the Internet. Currently, other forms of digital delivery including digital versatile disk (DVD), mini-disk (MD), and motion picture expert group layer 3 (MP3) inherently include metadata. Likewise, digital delivery systems including digital cable, direct broadcast satellite (DBS), satellite radio, digital broadcast radio, and Internet streaming media and multi-casting similarly include metadata about audio and video content, commonly referred to program-associated data (PAD). The provision of PAD or A/V metadata extends the digitized content value chain by facilitating a listener or viewer in acquiring their own copy of the associated content when they do not know the name of the artist or the title of the work.

A popular metadata format for digitized content is ID3, a file tagging system originally developed for including information such as artist, album name, song title, and track length with MP3-encoded audio files. The first version of ID3 appended a 128 byte block of data at the end of the MP3 file, which presented problems with some early MP3 players and also prevented ID3 information from being displayed as it was being played. The current version of ID3, version 2 and its variants, defines an extensible data structure limited to a total size of 256 MB, prepended as a block of code to the front of a digitized content file. The ID3v2 code block is comprised of frames, each of which can be up to 16 MB in size and can contain multiple types of A/V metadata, including but not limited to, lyrics, images, copyright information, and even Internet addresses where the A/V content can be obtained.

Currently, ID3 tags and other forms of digitized content metadata are viewed on the display screen of a content delivery system such as, but not limited to, a personal computer, a DVD disk player, a portable media player, a satellite radio receiver, or a video screen attached to a satellite or cable receiver. While these devices are generally used in the home, in an automobile, or carried by an individual, it is becoming increasingly common for venues such as restaurants, coffee shops, exhibition halls, and other public places to have large video screens and/or sound systems for the delivery of A/V content. The playing of music and/or video in these and other venues not only helps create an atmosphere or ambiance, but it often generates an impulsive desire for patrons to acquire their own copy of the content being played. In the past, the viewer or listener was frustrated because they often didn't know the title or artist name. Today however, it is not uncommon for some metadata to be displayed on a video screen as A/V content is played in these venues, even to the extent of providing the Internet address where the content can be purchased. Many of these same venues provide access to the Internet, often at no charge, for the convenience of their customers or attendees. Display of A/V content metadata, combined with access to the Internet provides the means for a listener or viewer to enter the appropriate metadata into an Internet-enabled device and purchase the associated content, which can either be downloaded in digitized form while the customer is still present in the venue, downloaded at a later time or on a different device, or delivered in physical form to a physical address.

However, entering metadata displayed on a video screen into an Internet-enabled device can present challenges. For example, the metadata may no longer be displayed by the time the listener can access and boot their laptop computer or PDA, or they may not have sufficient time to enter the required metadata into their browser, or it may be miss-keyed when entered. Furthermore, the impulse to purchase can quickly vanish if the purchase initiation process is too complicated, cumbersome, or takes too long. Similarly, if the purchase is delayed to a later time, the purchaser may forget to act on their initial impulse. In other cases, the content delivery system in a venue may be audio-only, with no means of displaying A/V content metadata, resulting in a prospective buyer not having the information necessary to purchase the associated content. Some Internet media streaming services such as Rhapsody make it possible to tag a song for purchase, but they require using the same device and media used to deliver the A/V content. While this approach may be convenient for users sitting in front of a computer, it is not always practical for would-be content purchasers in a public venue. In view of the foregoing, there is a need to automatically compensate stakeholders that further extend the digitized content value chain by providing A/V content metadata directly to Internet-enabled devices to facilitate the on-line purchase of associated content.

### SUMMARY OF THE INVENTION

Various embodiments of the present invention comprise a system and method for automatically compensating stakeholders in an extended value chain that facilitates the on-line purchase of a copy of digitized content. In these embodiments of the invention, metadata is decoupled from the digitized audio content before it is played and wirelessly simulcasted by a metadata simulcaster. In an embodiment of the invention, the simulcast metadata may comprise metadata contained within an ID3v2 tag.

In various embodiments, wireless devices receive the simulcast A/V metadata, including on-line purchase information, such as the content provider's Internet address, to facilitate purchasing a copy of the associated content. In an embodiment of the invention, the metadata includes information identifying stakeholders in an extended value chain who will receive a proportionate share of each on-line content sale they facilitate. Stakeholder information is presented at the time of purchase to proportionately allocate the proceeds of each on-line content sale to participating stakeholders in the extended digitized content value chain based on predetermined business agreements. On-line content providers and/or other intermediaries subsequently use the information to transfer funds to each stakeholder's respective bank account and provide remittance advice.

In one embodiment of the invention, supplemented A/V content metadata is “pushed” to the wireless device, where it is displayed as it is simulcasted by the metadata simulcaster. In another embodiment of the invention, the metadata simulcaster acts as a server to “pull” the wireless device user to simulcasted and/or stored and supplemented A/V content metadata. In yet another embodiment of the invention, the wireless user can access supplemented metadata of A/V content that was previously played. In other embodiments, the wireless device user can select supplemented A/V metadata for a single selection, an entire playlist, or a partial play list, and save the metadata to the wireless device to use as reference for later use when purchasing the associated content.

In some embodiments of the invention, the A/V content can be purchased, paid for, and downloaded from an on-line content provider's site to the buyer's wireless device through the venue's wireless access point. In another embodiment of the invention, the wireless device user can download the selected A/V content from a content delivery site that they subscribe to. In yet another embodiment of the invention, the wireless device user can elect to purchase a physical copy of the audio video/content from an on-line merchant and have it delivered to a physical address. In each of these embodiments of the invention, the supplemented metadata is presented at the time of on-line content purchase and contains information including the originating venue where the digitized content was played and other stakeholders contributing to the simulcasting of its associated metadata.

In various embodiments of the invention, digitized audio content containing metadata is received via a satellite radio, with the metadata similarly intercepted by a mobile metadata simulcaster and locally simulcasted via a wireless protocol such as, but not limited to, Bluetooth. The simulcasted metadata is received by similarly enabled wireless devices such as those described hereinabove, which uses the metadata to facilitate an on-line purchase of the audio content, in electronic or physical form, either at the present or a future time. In an embodiment of the invention, metadata from a satellite radio is simulcast to similarly enabled wireless devices in a stationary venue such as a home, office, or public place, and the associated audio content is purchased on-line through wireless or physical access to the Internet. In another embodiment of the invention, the satellite radio is implemented in a mobile environment, and the associated audio content is purchased on-line through a wireless wide area network (WWAN) connection to the Internet. Those of skill in the art will understand that many such embodiments and variations of the invention are possible, including but not limited to those described hereinabove, which are by no means all inclusive.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of an information handling system that can be used to implement the method and system of the present invention;

FIGS. 2a-b are generalized illustrations of a metadata tag as implemented in accordance with an embodiment of the invention to provide value chain stakeholder and purchase information metadata for digitized audio/video content;

FIGS. 3a-c are a generalized flowchart of a metadata simulcast system as implemented in accordance with an embodiment of the invention for the simulcasting of audio/video metadata to facilitate an on-line purchase of a copy of associated content;

FIG. 4 is a generalized block diagram illustrating an implementation of a metadata simulcaster as used in accordance with an embodiment of the invention for the simulcasting of audio/video metadata to a wireless device to facilitate an on-line purchase of an electronic copy of the associated content;

FIG. 5 is a generalized block diagram illustrating an implementation of a metadata simulcaster as used in accordance with an embodiment of the invention for the simulcasting of audio/video metadata to a wireless device to facilitate an on-line purchase of a physical copy of the associated content;

FIG. 6 is a generalized block diagram illustrating an implementation of a metadata simulcaster as used in accordance with an embodiment of the invention for the simulcasting of audio/video metadata to a wireless device to facilitate an on-line purchase of an electronic and/or physical copy of the associated content;

FIG. 7 is a generalized block diagram illustrating an implementation of a mobile metadata simulcaster as used in accordance with an embodiment of the invention for the simulcasting of audio metadata to a wireless device to facilitate an on-line purchase of a electronic or physical copy of the associated content in a mobile environment;

FIG. 8 is a generalized block diagram depicting a value chain as commonly implemented in the audio/video content industry;

FIGS. 9a-c are generalized block diagrams illustrating an implementation of a value chain model for the audio/video content industry in accordance with an embodiment of the invention;

FIG. 10 is a generalized block diagram illustrates an affiliate marketing revenue sharing system for the automatic allocation of each extended value chain stakeholder's proportionate share of an on-line content purchase that originated from simulcasted metadata in accordance with an embodiment of the invention, and;

FIG. 11 is a generalized block diagram of a simulcast content revenue sharing system as implemented in accordance with an embodiment of the invention.

### DETAILED DESCRIPTION

A system and method is disclosed for automatically compensating stakeholders in an extended value chain that facilitates the on-line purchase of a copy of digitized content in electronic or physical form, at the present or a later time. Metadata is decoupled from digitized audio content before it is played and wirelessly simulcasting the metadata such that it can be automatically received, stored and enacted upon by similarly enabled wireless devices.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

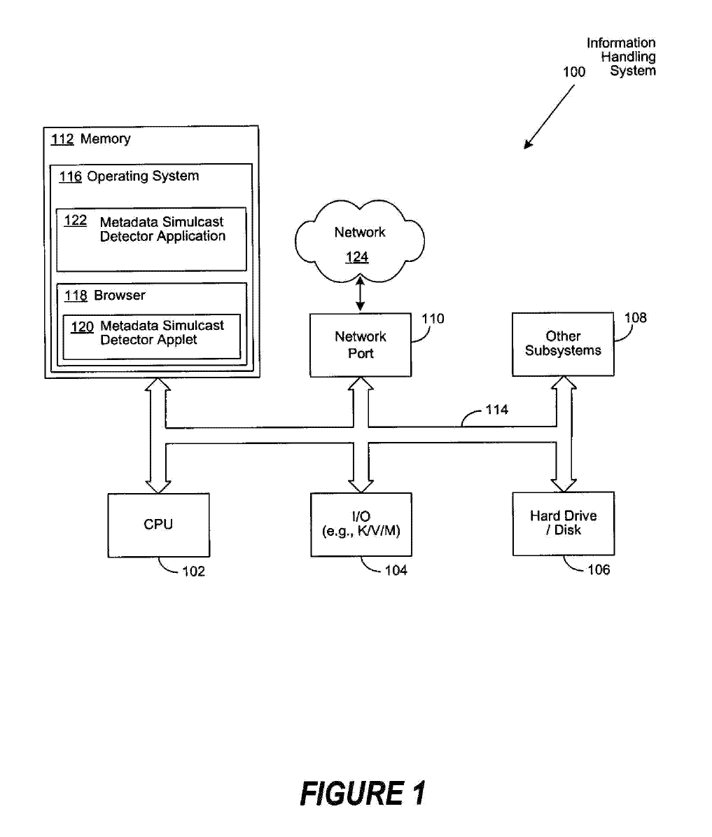

FIG. 1 is a generalized illustration of an information handling system 100 that can be used to implement the system and method of the present invention. The information handling system includes a processor (e.g., central processor unit or “CPU”) 102, input/output (I/O) devices 104, such as a display, a keyboard, a mouse, and associated controllers, a hard drive or disk storage 106, various other subsystems 108, network port 110 operable to connect to a network 124, and system memory 112, all interconnected via one or more buses 114. Operating system 116 resides in system memory 112 and in an embodiment of the invention supports an implementation of a Web browser 118 which can be utilized by the present invention for implementation of metadata simulcast detector applet 120. Operating system 116 further supports implementation of metadata simulcast detector application 122, which does not require the implementation of a browser.

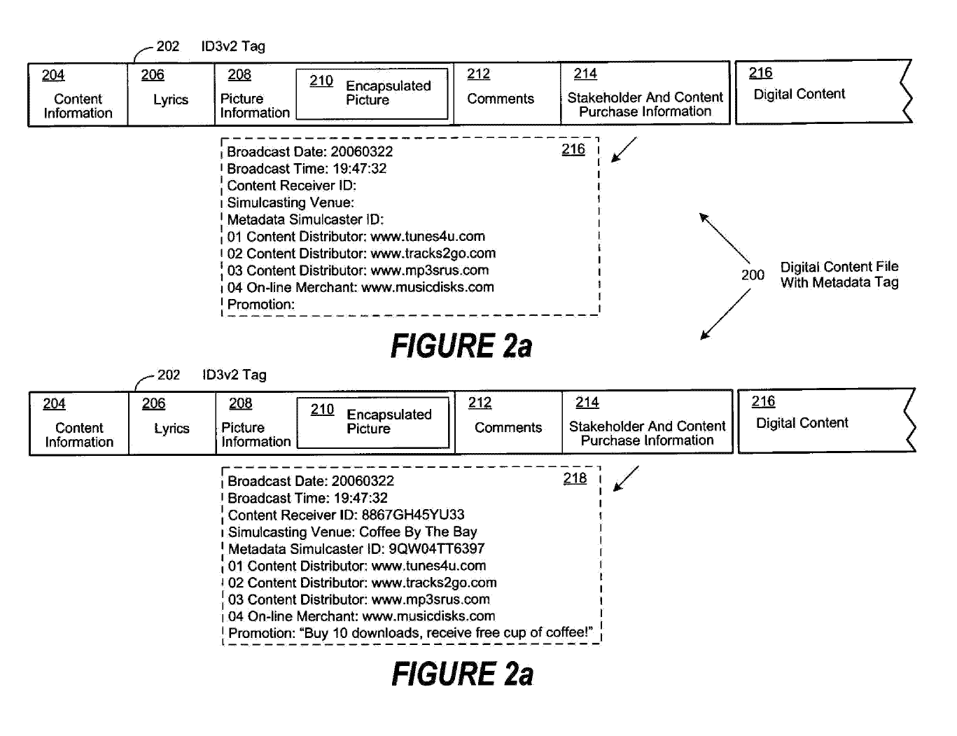

FIG. 2 is a generalized illustration of a prior art ID3v2 tag 202 as commonly implemented to provide metadata for digitized audio/video (A/V) content 216. In this illustration, a digital content file with associated metadata 200 comprises ID3v2 tag 202 prepended to digitized A/V content 216. ID3v2 tag 202 comprises, but is not limited to, content data 204, lyrics 206, picture information 208, which further comprises encapsulated picture 210, comments 212, and content purchase information 214. Content data 204 comprises, but is not limited to, song title, artist name, album name, year produced, track number, track length, and genre. Content purchase information 214 comprises information facilitating the on-line purchase of the associated A/V content including, but not limited to, the Internet address of on-line content providers, pricing, special promotions, availability dates, and copyright information. For example, those of skill in the art familiar with ID3v2 metadata tags will recognize that its extensible data structure, which is comprised of frames, allows the flexible accommodation of these types of metadata, which can be simulcast in accordance with different embodiments of the invention.

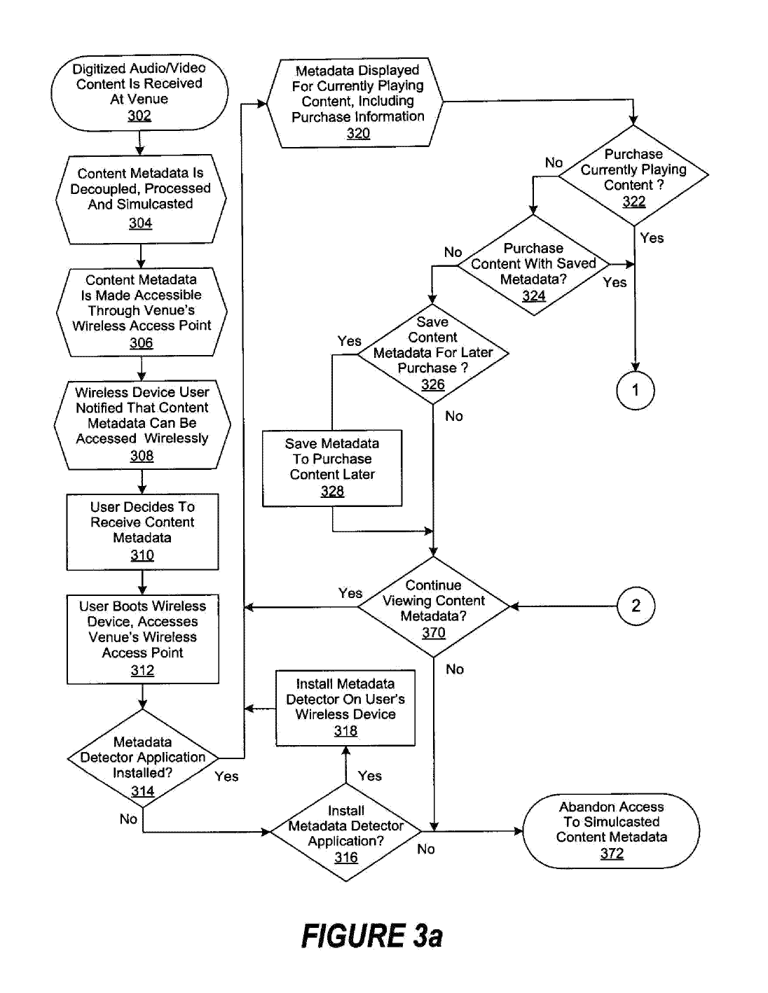

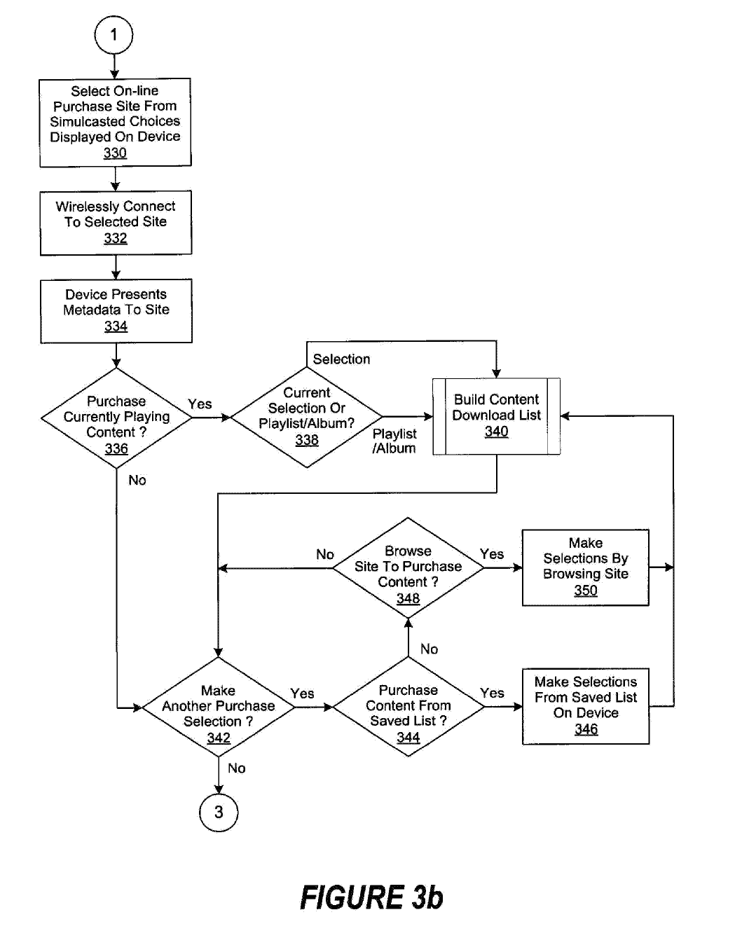

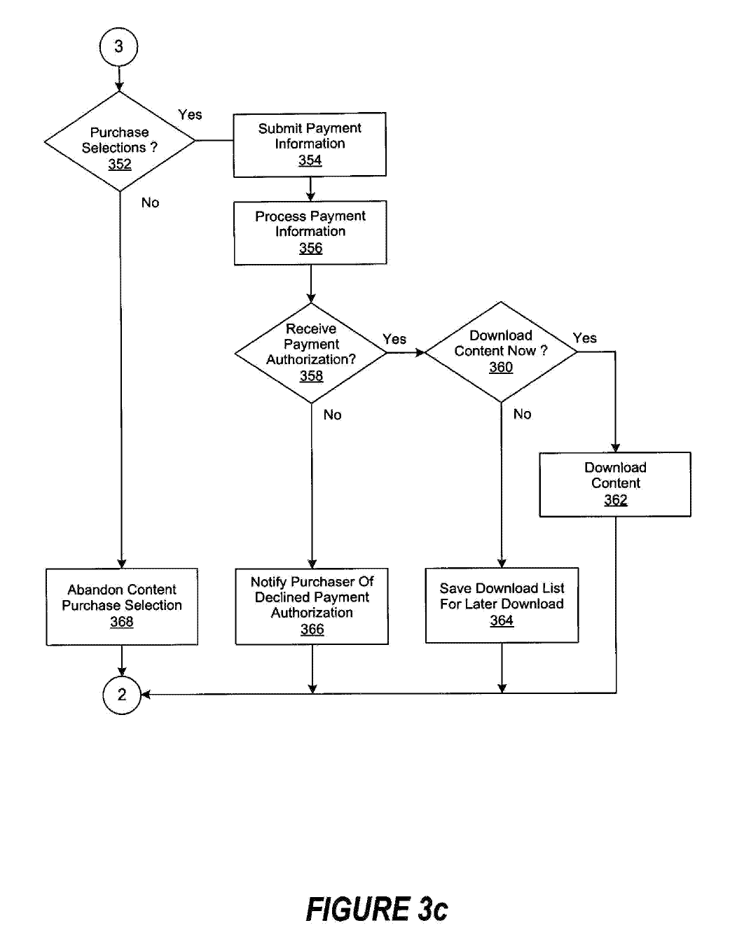

FIG. 3 is a generalized flowchart of a metadata simulcast system as implemented in accordance with an embodiment of the invention for the simulcasting of audio/video (A/V) metadata to facilitate an on-line purchase of a copy of associated content. In step 302, a digitized A/V content stream is received at a venue which can include, but is not limited to, an office, a public place, a private home, or a mobile vehicle. In step 304, a metadata simulcaster, as implemented in accordance with an embodiment of the invention, decouples metadata from the incoming A/V content stream, stores it internally on the metadata simulcaster or on an external host for remote and/or later retrieval, and simulcasts it as it is being played by a digital content player. In different embodiments of the invention, decoupled metadata is time stamped and supplemental metadata is appended or substituted including, but not limited to, unique identifiers of the venue where the content is being played, Internet addresses of on-line providers of the A/V content, and special promotions prior to it being stored and simulcast.

In step 306, decoupled and processed metadata is wirelessly simulcast by the metadata simulcaster using one or more protocols such as, but not limited to, 802.11 (WiFi), short message service (SMS), Bluetooth, or general packet radio service (GPRS). In step 308, wireless device users are notified that metadata associated with the A/V content being played is available for access by wireless-enabled devices including, but not limited to, laptop computers, personal digital assistants (PDAs), portable media players and cell phones. In one embodiment of the invention, notification is displayed on a video screen along with the metadata while the content is being played. In another embodiment of the invention, such as in an audio-only environment, wireless device users are notified when they access the venue's wireless access point for access to the Internet. In another embodiment of the invention in an audio-only environment, wireless device users are notified of the availability of A/V content metadata verbally or through printed materials.

In step 310, the wireless device user decides to receive simulcasted A/V content metadata, and in step 312 boots their wireless device to connect to the venue's wireless access point. If it is determined in step 314 that a metadata detector application or applet is currently implemented on the user's wireless device, then links to the A/V content metadata or the metadata itself is displayed on the wireless device in step 320 The displayed or linked metadata can include information facilitating an on-line purchase of the associated A/V content as described in greater detail hereinabove.

Otherwise, the wireless device user is prompted in step 316 to install a metadata detector application or applet. In one embodiment of the invention, the A/V metadata detector application or applet automatically detects and displays A/V content metadata that is simulcasted, or “pushed”, by the metadata simulcaster. In another embodiment of the invention, the metadata detector application or applet displays an advisory screen or link to “pull” the wireless device user to the metadata simulcaster, which acts as a server for providing simulcasted and/or stored A/V content metadata. If the wireless device user decides to not install a metadata detector application or applet in step 316, then access to simulcasted A/V content metadata is abandoned in step 372. If the wireless device user decides to install a metadata detector application or applet in step 316, then it is installed on the user's wireless device in step 318. Once the metadata detector application or applet is installed, links to the A/V content metadata or the metadata itself, including information facilitating an on-line purchase of the associated A/V content, is displayed on the wireless device in step 320 as described in greater detail hereinabove. The wireless device user is then prompted in step 322 to purchase the associated A/V content. If the wireless device user decides to not purchase the associated A/V content in step 324, then they are prompted in step 324 to purchase other A/V content with previously saved metadata. If the wireless device user decides to not purchase other A/V content in step 324, they are prompted in step 326 to save the A/V content metadata for facilitating a later purchase of the associated A/V content.

If the wireless device user decides in step 326 to save the A/V content metadata, then the metadata is stored on their wireless device in step 328. If the wireless device user decides in step 326 to not save the A/V content metadata, then they are prompted in step 370 to continue viewing A/V content metadata. If the wireless device user decides in step 370 to continue viewing A/V content metadata, then the wireless device user is returned to step 320 and the process continues. If the wireless device user decides in step 370 to not continue viewing A/V content metadata, then access to simulcasted A/V content metadata is abandoned in step 372. If the wireless device user decides to purchase the currently playing associated A/V content in step 322, or purchase other content with previously saved A/V metadata in step 324, then they select an on-line purchase site from choices displayed by the metadata detector application or applet implemented on their device in step 330. Once an on-line site is selected, they are then wirelessly connected to the chosen site in step 332. Once connected to the on-line content purchase site, the metadata detector application or applet implemented on the wireless device presents supplemented metadata associated with the currently playing A/V content to the on-line purchase site in step 334.

The on-line content purchase site accepts the supplemented A/V content metadata and prompts the wireless device user to purchase the associated A/V content in step 336. If the Wireless device user decides to purchase the associated A/V content, they are prompted in step 338 to purchase either the individual A/V content selected, or other associated A/V content as well, such as but not limited to, other A/V content on a referenced playlist or an album. A content download list is built in step 340, dependent upon the purchase decisions made by the wireless device user in step 338, and once the content download list is completed, the wireless device user is prompted to make additional purchase selections in step 342. If the wireless device user decides to not make any additional purchase selections in step 342, they are prompted in step 352 to purchase their content selections. If the wireless device user decides not to purchase their content selections in step 352, then they abandon content purchase selection in step 368 and they are then prompted in step 370 to continue viewing content metadata. If the wireless device user decides in step 370 to not continue viewing supplemented A/V content metadata, then access to simulcasted and supplemented A/V content metadata is abandoned in step 372. Otherwise, they are returned to step 320 and viewing of supplemented A/V content metadata resumes.

If the wireless device user decides to make additional purchase selections in step 342, they are prompted in step 344 to make additional content purchase selections from the supplemented A/V metadata list saved by the metadata detector application or applet on their wireless device. If the wireless device user decides to make content purchase selections from the supplemented A/V metadata list on their wireless device, then they do so in step 346 and the selected A/V content is added to the content download list in step 340 and they are prompted to make additional content purchase selections in step 338. If the wireless device user decides to make additional purchase selections in step 342, they are prompted once again in step 344 to make additional content purchase selections from the supplemented A/V metadata list saved by the metadata detector application or applet on their wireless device. If they do, the process is repeated, and once completed, the wireless device user is returned to step 344. If the wireless device user decides in step 344 to not make additional content purchase selections from the supplemented A/V metadata list saved by the metadata detector application or applet on their wireless device, they are prompted in step 348 to make content purchase selections by browsing the on-line content purchase site.

If the wireless device user decides to make additional content purchase selections by browsing the on-line content purchase site, then A/V content selections are made in step 350, the selections are added to the content download list in step 340, and the wireless device user is returned to step 342. If the wireless device user decides to not make any additional purchase selections in step 342, they are prompted in step 352 to purchase their content selections. If the wireless device user decides not to purchase their content selections in step 352, then they abandon content purchase selection in step 368 and are then prompted in step 370 to continue viewing content metadata. If the wireless device user decides in step 370 to not continue viewing supplemented A/V content metadata, then access to simulcasted and supplemented A/V content metadata is abandoned in step 372. Otherwise, they are returned to step 320 and viewing of supplemented A/V content metadata resumes.

If the wireless device user decides to purchase their content selections in step 352, then they submit payment information details in step 354 and the payment information is processed for authorization in step 356. If payment authorization is not received in step 358, the wireless device user is notified of the declined payment authorization in step 366 and they are then prompted in step 370 to continue viewing content metadata. If the wireless device user decides in step 370 to not continue viewing supplemented A/V content metadata, then access to simulcasted and supplemented A/V content metadata is abandoned in step 372. Otherwise, they are returned to step 320 and viewing of supplemented A/V content metadata resumes.

If payment authorization is received in step 358, the wireless device user is prompted to download the list of purchased A/V content in step 360. If the wireless device user decides to not download the list of purchased A/V content in step 360, the list of purchased A/V content is saved for later download in step 364 and the wireless device user is prompted in step 370 to continue viewing content metadata. If the wireless device user decides in step 370 to not continue viewing supplemented A/V content metadata, then access to simulcasted and supplemented A/V content metadata is abandoned in step 372. Otherwise, they are returned to step 320 and viewing of supplemented A/V content metadata resumes. If the wireless device user decides to download the list of purchased A/V content in step 360, then the purchased A/V content is downloaded in step 362 and the wireless device user is prompted in step 370 to continue viewing content metadata. If the wireless device user decides in step 370 to not continue viewing supplemented A/V content metadata, then access to simulcasted and supplemented A/V content metadata is abandoned in step 372. Otherwise, they are returned to step 320 and viewing of supplemented A/V content metadata resumes.

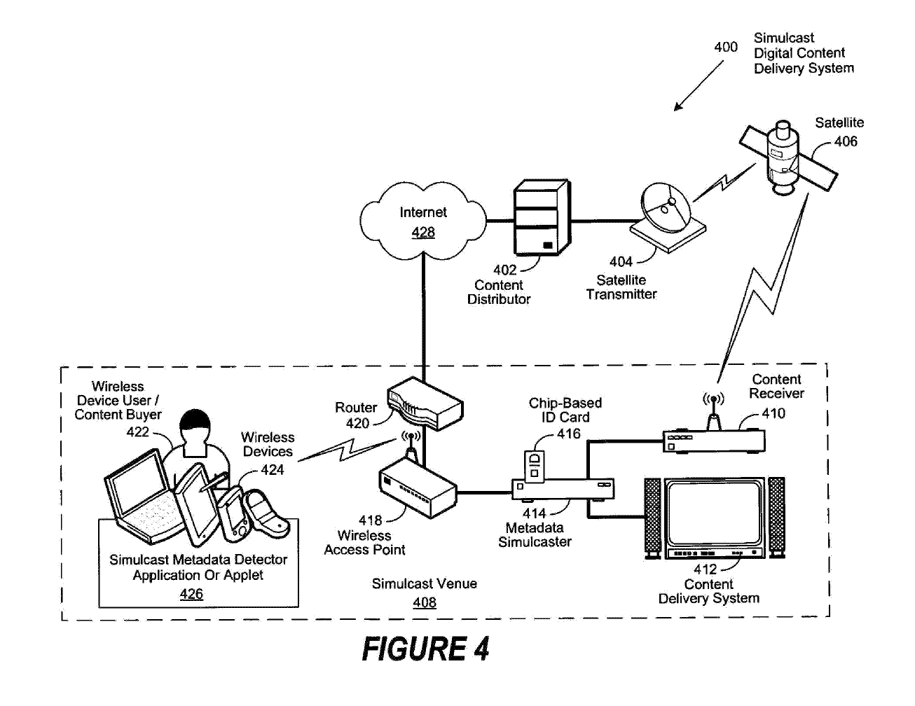

FIG. 4 is a generalized block diagram illustrating an implementation of a metadata simulcaster 414 as used in accordance with an embodiment of the invention for the simulcasting of audio/video (A/V) metadata to a wireless device to facilitate an on-line purchase of an electronic copy of the associated content. In this embodiment of the invention, simulcast digital content delivery system 400 comprises content distributor 402, coupled to the Internet 428 and satellite transmitter 404, satellite 406, and simulcast venue 408. Content distributor 402 streams predetermined A/V content with associated metadata to satellite transmitter 404, which transmits it to satellite 406 for broadcast to simulcast venue 408.

Simulcast venue 408 comprises content receiver 410, A/V content delivery system 412, A/V metadata simulcaster 414, wireless access point 418, router 420, wireless device user/content buyer 422 and wireless devices 424 implemented with metadata simulcast detector application or applet 426. In an embodiment of the invention, digitized A/V content broadcast from satellite 406 is received by content receiver 410, where it is intercepted by metadata simulcaster 414, which decouples and simulcasts metadata associated with the A/V content as it is being played by content delivery system 412. In different embodiments of the invention, decoupled metadata is time stamped and supplemental metadata is appended or substituted including, but not limited to, unique identifiers of the venue where the content is being played, Internet addresses of on-line providers of the A/V content, and special promotions. In an embodiment of the invention, metadata simulcaster 414 comprises a chip-based identification card 416, which provides metadata origination information to facilitate an on-line purchase of associated A/V content. After A/V content metadata is decoupled from the intercepted digitized A/V content stream and processed, it is then stored internally in metadata simulcaster 414 or on an external host for remote and/or later retrieval. Metadata simulcaster 414 then wirelessly simulcasts the processed metadata through wireless access port 418 using one or more protocols such as, but not limited to, 802.11 (WiFi), short message service (SMS), or general packet radio service (GPRS).

Wireless device users who are potential A/V content buyers 422 are notified that metadata associated with the A/V content currently being played is available through the use of wireless-enabled devices 424 including, but not limited to laptop computers, personal digital assistants (PDAs), portable media players and cell phones. In one embodiment of the invention, notification is displayed on a video screen of content delivery system 412 along with the metadata. In another embodiment of the invention, such as when content delivery system 412 only provides audio, wireless device users/content buyers 422 are notified when they access the venue's wireless access point 418 for access to the Internet 428. In another embodiment of the invention in an audio-only environment, wireless device users/content buyers 422 are notified of the availability of A/V content metadata verbally or through printed materials.

Wireless device users/content buyers 422 who decide to receive simulcasted A/V content metadata boot their wireless devices 424 to connect to the venue's wireless access point 418 at which point the wireless device user/content buyer 422 is prompted to install metadata detector application or applet 426. In one embodiment of the invention, the A/V metadata detector application or applet automatically detects and displays A/V content metadata that is simulcasted, or “pushed”, by the metadata simulcaster. In another embodiment of the invention, the metadata detector application or applet displays an advisory screen or link to “pull” the wireless device user to the metadata simulcaster, which acts as a server for providing simulcasted and/or stored A/V content metadata. Once a metadata detector application or applet 426 is installed on a wireless device 424, A/V content metadata, including information facilitating an on-line purchase of the associated A/V content, is displayed on the wireless device 424 as described in greater detail hereinabove. In an embodiment of the invention, A/V content metadata displayed on wireless devices 424 includes time-stamped and supplemental metadata including, but not limited to, unique identifiers of the venue 408 where the content is being played, Internet addresses of on-line providers of the A/V content, and special promotions.

In this embodiment of the invention, the wireless device user/content buyer 422 can use the displayed A/V content metadata to facilitate the enactment of an on-line purchase of the associated A/V content. When the wireless device user/content buyer 422 decides to purchase the associated A/V content, they are wirelessly connected to content distributor 402 through wireless access point 418, which is connected to router 420, which in turn is coupled to the Internet 428. Once connected to content distributor 402, the wireless device user/content buyer 422 conducts and completes a purchase of the associated A/V content. Once the purchase is completed, the associated A/V content is downloaded through Internet 428, through router 420 and wireless access point 418, and on to wireless devices 424. In another embodiment of the invention, if the wireless device user 422 decides not to purchase the associated A/V content at that time, the A/V content metadata is saved to the wireless device 424 facilitating a later purchase of the associated A/V content.

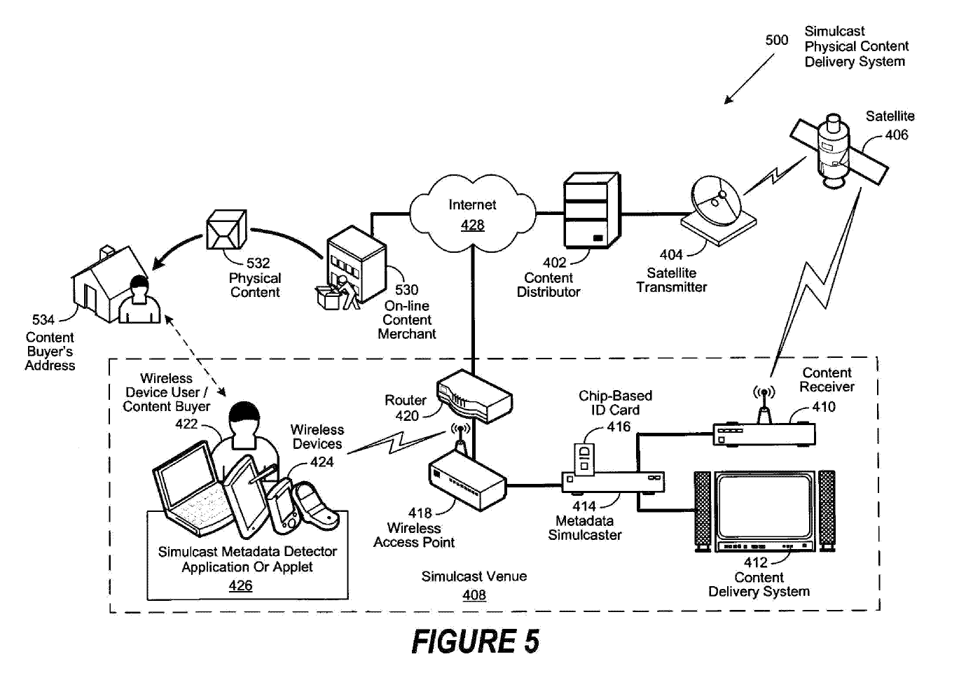

FIG. 5 is a generalized block diagram illustrating an implementation of a metadata simulcaster 414 as used in accordance with an embodiment of the invention for the simulcasting of audio/video (A/V) metadata to a wireless device to facilitate an on-line purchase of a physical copy of the associated content. In this embodiment of the invention, simulcast physical content delivery system 500 comprises content distributor 402, coupled to the Internet 428 and satellite transmitter 404, satellite 406, simulcast venue 408, on-line content merchant 530, physical content 532, and content buyer's address 534. Content distributor 402 streams predetermined A/V content with associated metadata to satellite transmitter 404, which transmits it to satellite 406 for broadcast to simulcast venue 408.

Simulcast venue 408 comprises content receiver 410, A/V content delivery system 412, A/V metadata simulcaster 414, wireless access point 418, router 420, wireless device user/content buyer 422 and wireless devices 424 implemented with metadata simulcast detector application or applet 426. In an embodiment of the invention, digitized A/V content broadcast from satellite 406 is received by content receiver 410, where it is intercepted by metadata simulcaster 414, which decouples and simulcasts metadata associated with the A/V content as it is being played by content delivery system 412. In different embodiments of the invention, decoupled metadata is time stamped and supplemental metadata is appended or substituted including, but not limited to, unique identifiers of the venue where the content is being played, Internet addresses of on-line providers of the A/V content, and special promotions. In an embodiment of the invention, metadata simulcaster 414 comprises a chip-based identification card 416 which provides metadata origination information to facilitate an on-line purchase of associated A/V content. After A/V content metadata is decoupled from the intercepted digitized A/V content stream, processed, and stored for remote and/or later retrieval, it is simulcasted by metadata simulcaster 414 and wireless device users who are potential A/V content buyers 422 are notified that metadata associated with the A/V content currently being played is available, as described in greater detail hereinabove.

Wireless device users/content buyers 422 who decide to receive simulcasted A/V content metadata then boot their wireless devices 424, connect to the venue's wireless access point 418, install a metadata detector application or applet 426, and access simulcasted metadata as described in greater detail hereinabove. In an embodiment of the invention, A/V content metadata displayed on wireless devices 424 includes time-stamped and supplemental metadata including, but not limited to, unique identifiers of the venue 408 where the content is being played, Internet addresses of on-line providers of the A/V content, and special promotions. In this embodiment of the invention, the wireless device user/content buyer 422 can use the displayed A/V content metadata to facilitate the enactment of an on-line purchase of the associated A/V content. In an embodiment of the invention, the wireless device user/content buyer 422 is given the option of using the simulcast metadata to facilitate purchasing a physical copy of the associated A/V content from on-line content merchant 530 and having it delivered to a physical address.

In this embodiment of the invention, the wireless device user/content buyer 422 connects to on-line content merchant 530 and provides shipping and payment details required to purchase of a physical copy of the album containing the associated A/V content. Once the purchase is completed, on-line content merchant 530 ships a physical copy of the associated A/V content 532 to the physical address 534 specified by the wireless device user/content buyer 422. In another embodiment of the invention, the wireless device user/content buyer stores purchase details including, but not limited to, name, shipping and billing addresses, phone numbers, and purchase card information, which can be automatically submitted to on-line content merchant 530 to further facilitate the purchase of associated A/V content. In another embodiment of the invention, if the wireless device user 422 decides not to purchase the associated A/V content at that time, the A/V content metadata is saved to the wireless device 424 facilitating a later purchase of the associated A/V content.

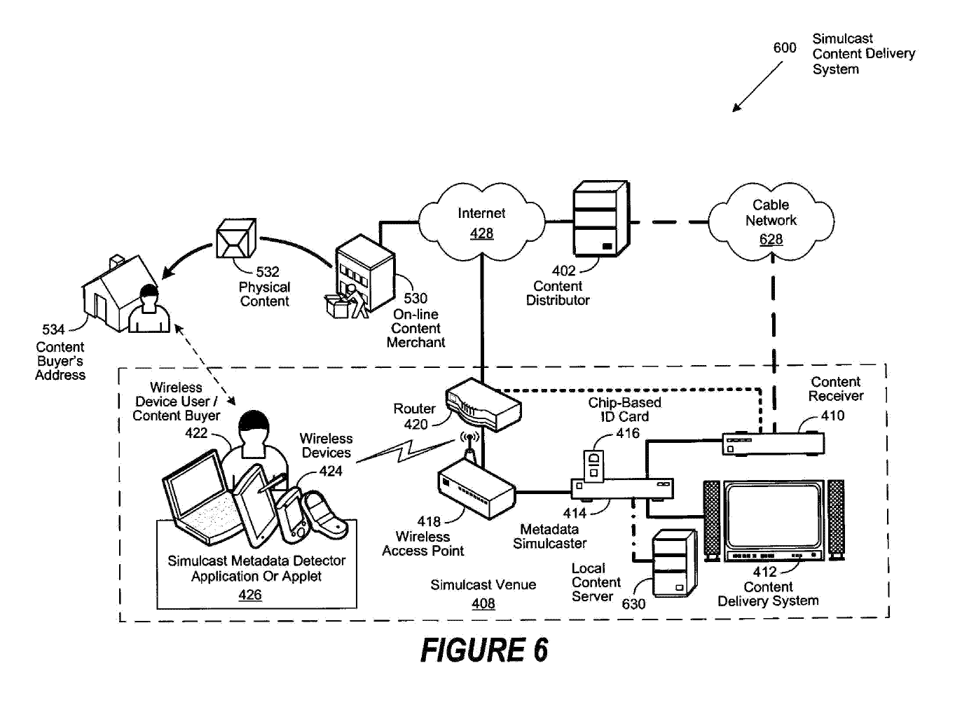

FIG. 6 is a generalized block diagram illustrating an implementation of a metadata simulcaster 414 as used in accordance with an embodiment of the invention for the simulcasting of audio/video (A/V) metadata to a wireless device to facilitate an on-line purchase of an electronic and/or physical copy of the associated content. In this embodiment of the invention, simulcast physical content delivery system 600 comprises content distributor 402, coupled to the Internet 428 and cable network 628, simulcast venue 408, on-line content merchant 530, physical content 532, and content buyer's address 534. Content distributor 402 streams predetermined A/V content with associated metadata through cable network 628 for delivery to simulcast venue 408.

Simulcast venue 408 comprises content receiver 410, A/V content delivery system 412, A/V metadata simulcaster 414, wireless access point 418, router 420, wireless device user/content buyer 422 and wireless devices 424 implemented with metadata simulcast detector application or applet 426. In an embodiment of the invention, digitized A/V content received from content distributor 402 via cable network 628 by content receiver 410 where it is intercepted by metadata simulcaster 414, which decouples and simulcasts metadata associated with the A/V content as it is being played by content delivery system 412. In another embodiment, digitized contend is received from content distributor 402 via Internet 428 by content receiver 410 where it is intercepted by metadata simulcaster 414, which decouples and simulcasts metadata associated with the A/V content as it is being played by content delivery system 412. In yet another embodiment, digitized content is not received from content distributor 402 via cable network 628 or Internet 428. Instead, it is received in physical form and stored on local content server 630, where it is conveyed to metadata simulcaster 414, which decouples and simulcasts metadata associated with the A/V content as it is being played by content delivery system 412. In different embodiments of the invention, decoupled metadata is time stamped and supplemental metadata is appended or substituted including, but not limited to, unique identifiers of the venue where the content is being played, Internet addresses of on-line providers of the A/V content, and special promotions. In an embodiment of the invention, metadata simulcaster 414 comprises a chip-based identification card 416 which provides metadata origination information to facilitate an on-line purchase of associated A/V content. After A/V content metadata is decoupled from the intercepted digitized A/V content stream, processed, and stored for remote and/or later retrieval, it is simulcasted by metadata simulcaster 414 and wireless device users who are potential A/V content buyers 422 are notified that metadata associated with the A/V content currently being played is available, as described in greater detail hereinabove.

Wireless device users/content buyers 422 who decide to receive simulcasted A/V content metadata then boot their wireless devices 424, connect to the venue's wireless access point 418, install a metadata detector application or applet 426, and access simulcasted metadata as described in greater detail hereinabove. In an embodiment of the invention, A/V content metadata displayed on wireless devices 424 includes time-stamped and supplemental metadata including, but not limited to, unique identifiers of the venue 408 where the content is being played, Internet addresses of on-line providers of the A/V content, and special promotions. In this embodiment of the invention, the wireless device user/content buyer 422 can use the displayed A/V content metadata to facilitate the enactment of an on-line purchase of the associated A/V content. In an embodiment of the invention, the wireless device user/content buyer 422 is given the option of using the simulcast metadata to facilitate purchasing a physical copy of the associated A/V content from on-line content merchant 530 and having it delivered to a physical address, or purchasing an electronic copy from content distributor 402, or both.

In this embodiment of the invention, the wireless device user/content buyer 422 connects to on-line content merchant 530 and provides shipping and payment details required to purchase of a physical copy of the album containing the associated A/V content. Once the purchase is completed, on-line content merchant 530 ships a physical copy of the associated A/V content 532 to the physical address 534 specified by the wireless device user/content buyer 422. The wireless device user/content buyer 422 then connects to content distributor 402 to conduct and complete the purchase of an electronic copy of the associated A/V content. Once the purchase is completed, the associated A/V content is downloaded through Internet 428, through router 420 and wireless access point 418, and on to wireless devices 424. In another embodiment of the invention, the wireless device user/content buyer stores purchase details including, but not limited to, name, shipping and billing addresses, phone numbers, and purchase card information, which can be automatically submitted to on-line content merchant 530 to further facilitate the purchase of associated A/V content. In another embodiment of the invention, the wireless device user/content buyer 422 downloads the selected A/V content from a content delivery site that they subscribe to, but is not included in the simulcasted A/V content metadata. In another embodiment of the invention, if the wireless device user 422 decides not to purchase the associated A/V content at that time, the A/V content metadata is saved to the wireless device 424 facilitating a later purchase of the associated A/V content. In other embodiments of the invention, wireless device users/content buyers 422 select metadata for a single selection, an entire playlist, or a partial play list, and save the metadata to the wireless device to use as reference for a later purchase of the associated A/V content.

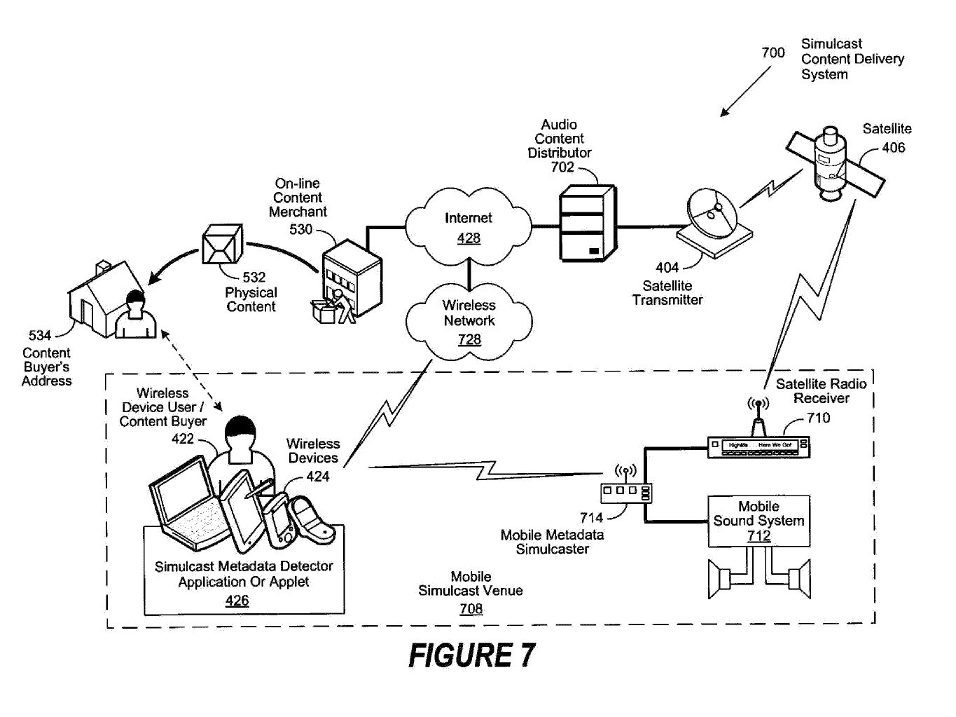

FIG. 7 is a generalized block diagram illustrating an implementation of a mobile metadata simulcaster 714 as used in accordance with an embodiment of the invention for the simulcasting of audio metadata to a wireless device to facilitate an on-line purchase of a electronic or physical copy of the associated content in a mobile environment. In this embodiment of the invention, simulcast digital content delivery system 700 comprises audio content distributor 702, coupled to the Internet 428 and satellite transmitter 404, satellite 406, mobile simulcast venue 708, wireless network 728, on-line content merchant 530, physical content 532, and content buyer's address 534. Wireless network 728 comprises a wireless wide area network (WWAN) implementing communication protocols including, but not limited to, general packet radio (GPRS), Enhanced Data rates for Global Evolution (EDGE), or IEEE 802.16 (WiMAX). Audio content distributor 702 streams predetermined audio content with associated metadata to satellite transmitter 404, which transmits it to satellite 406 for broadcast to mobile simulcast venue 708.

Mobile simulcast venue 708 comprises satellite radio receiver 710, mobile sound system 712, mobile metadata simulcaster 714, wireless device user/content buyer 422, and wireless devices 424 implemented with metadata simulcast detector application or applet 426. In an embodiment of the invention, digitized A/V content broadcast from satellite 406 is received by satellite radio receiver 710 where it is intercepted by mobile metadata simulcaster 714, which decouples and simulcasts metadata associated with the audio content as it is being played by mobile content delivery system 712. In different embodiments of the invention, decoupled metadata is time stamped and supplemental metadata is appended or substituted including, but not limited to, unique identifiers of the venue where the content is being played, Internet addresses of on-line providers of the audio content, and special promotions. After audio content metadata is decoupled from the intercepted digitized audio content stream, it is processed and stored for later retrieval, on mobile metadata simulcaster 714, which then directly simulcasts the resulting metadata using one or more protocols such as, but not limited to, 802.11 (WiFi), global packet radio service (GPRS), short message service (SMS), or Bluetooth.

Wireless device users who are potential audio content buyers 422 are notified as described in greater detail hereinabove that metadata associated with the audio content being played is available through the use of wireless-enabled devices 424 including, but not limited to laptop computers, personal digital assistants (PDAs), portable media players and cell phones. Wireless device users/content buyers 422 who decide to receive simulcasted audio content metadata boot their wireless devices 424 to directly connect to mobile decoder/simulcaster 714 at which point the wireless device user/content buyer 422 is prompted to install a metadata detector application or applet 426. In one embodiment of the invention, the metadata detector application or applet 426 is downloaded through wireless network 728, which in turn is connected to the Internet 726. In one embodiment of the invention, the audio metadata detector application or applet 426 automatically detects and displays audio content metadata that is simulcasted, or “pushed”, by mobile metadata simulcaster 714. In another embodiment of the invention, the metadata detector application or applet 426 displays an advisory screen or link to “pull” the wireless device user/content buyer 422 to the mobile metadata simulcaster 714, which acts as a server for providing simulcasted and/or stored audio content metadata. Once a metadata detector application or applet 426 is installed on a wireless device 424, audio content metadata, including information facilitating an on-line purchase of the associated audio content, is displayed on the wireless device 424 as described in greater detail hereinabove.

In an embodiment of the invention, audio content metadata displayed on wireless devices 424 includes time-stamped and supplemental metadata including, but not limited to, unique identifiers of the mobile venue 708, such as how the content is being played (e.g., the unique electronic identifier of the satellite radio receiver), Internet addresses of on-line providers of the audio content, and special promotions. In this embodiment of the invention, the wireless device user/content buyer 422 can use the displayed audio content metadata to facilitate the enactment of an on-line purchase of the associated audio content. In an embodiment of the invention, the wireless device user/content buyer 422 is given the option of using the simulcast metadata to facilitate purchasing a physical copy of the associated audio content from on-line content merchant 530 and having it delivered to a physical address, or purchasing an electronic copy from audio content distributor 702, or both.

In this embodiment of the invention, the wireless device user/content buyer 422 connects to on-line content merchant 530 via wireless network 728, described in greater detail hereinabove, which in turn is coupled to the Internet 428, and provides shipping and payment details required to purchase of a physical copy of the album containing the associated audio content. Once the purchase is completed, on-line content merchant 530 ships a physical copy of the associated audio content 532 to the physical address 534 specified by the wireless device user/content buyer 422. The wireless device user/content buyer 422 then connects to audio content distributor 702 to conduct and complete the purchase of an electronic copy of the associated audio content. Once the purchase is completed, the associated audio content is downloaded through Internet 428, through wireless network 728, and on to wireless device 424.

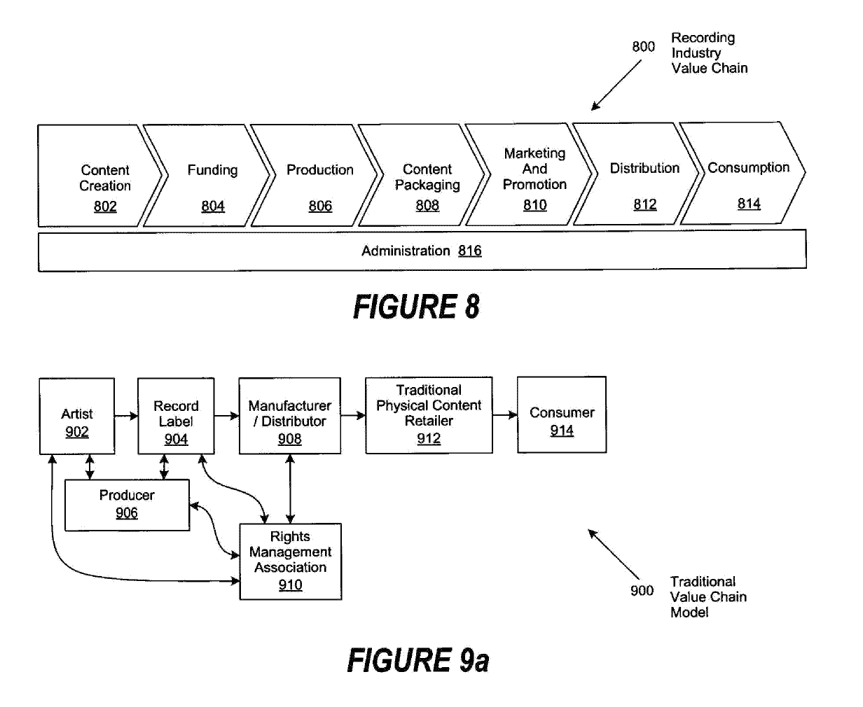

FIG. 8 is a generalized block diagram depicting a value chain as commonly implemented in the audio/video content industry. In this depiction, recording industry value chain 800 comprises the creation of audio/video (A/V) content 802, which is funded 804 for production 806 and content packaging 808. Once these phases have been completed, the packaged A/V content is marketed and promoted 810 and distributed 812 for consumption 814, with administration 816 by a plurality of stakeholders occurring throughout the lifecycle of these phases.

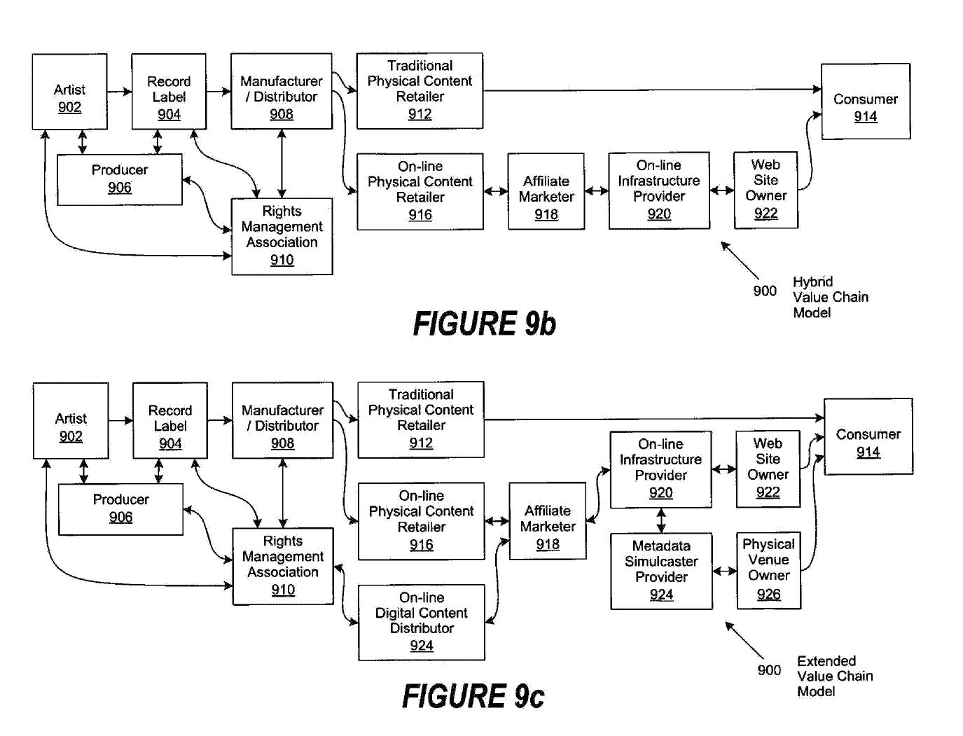

FIG. 9 is generalized block diagrams illustrating an implementation of a value chain model 900 for the audio/video content industry in accordance with an embodiment of the invention. FIG. 9a depicts a generalized block diagram illustrating participants in a traditional audio/video (A/V) recording industry value chain. In this illustration, one or more performing artists 902 are associated with a record label 904, each of whom work in conjunction with a producer 906 to produce A/V content, which is manufactured, packaged and distributed by one or more manufacturer/distributors 908 to a plurality of traditional physical content retailers 912 for consumption by consumers 914. One component of this traditional value chain is one or more rights management associations 910, exemplified by the Recording Industry Association of America (RIAA) and American Society of Composers, Artists and Producers (ASCAP). These rights management associations 910 interact with manufacturer/distributors 908 to represent the legal and financial rights of performing artists 902, producers 906 and the record labels 904.

In general, each of these participants receives a proportionate share of each retail content sale. For example, according to current industry sources, composers and publishers share approximately 8-9% of the retail price, artists receive anywhere from 6-10%, producers receive on the order of 2%, record labels can receive 24-40%, distributors generally receive 15-30% dependent upon the services and value they contribute, and the retailer receives 12-27%. In addition, 9-15% or the retail price is usually allocated for promotion and advertising. The advent of the Internet has facilitated the on-line sale of physical A/V content, as generally illustrated in FIG. 9b. In addition to the on-line physical A/V content retailer 916, other participants such as affiliate marketers 918, on-line infrastructure providers 920 (e.g., Internet service providers, cable network multiple service operators, etc.), website owners 922, and other intermediaries now represent a hybrid value chain model for the sale of physical A/V content.

Of these, the role of the affiliate marketer 918 has gained importance in recent years, as they provide a method of promoting on-line sales in which affiliates (e.g., on-line infrastructure providers 920, website owners 922, etc.) are rewarded for on-line physical content retailer 916 sales that result from their efforts or participation. This business arrangement is similar to the traditional practice of paying finder's-fees for the introduction of new customers. Compensation to the affiliate is generally based on a predetermined value for each customer visit (e.g., pay per click), each visitor to the site (e.g., pay per registration or opt-in agreement), commission for each sale (e.g., a percentage of the sale), or any combination thereof. In this pay-for-performance model, the on-line physical content retailer only pays when they receive predetermined value and no payment is due to an affiliate until results are realized. The administration of these relationships is typically managed through software applications provided and administered by the affiliate marketer 918, who likewise receives predetermined compensation for enabling the affiliate relationships and their resulting transactions.

The introduction and growing popularity of digitally encoded A/V content such as, but not limited to motion pictures expert group layer 3 (MP3) audio files, has made the downloading and sale of A/V content convenient. This phenomenon has resulted in the emergence of an extended value chain model for the A/V recording industry, generally illustrated in FIG. 9c, which depicts the addition of on-line digital content distributor 924, currently typified by iTunes, provided by Apple Computer, Yahoo Music, and Napster. In general, on-line digital content distributors maintain a relationship with rights management associations 910 to ensure that the legal and financial rights of their constituents are observed and maintained.

However, fundamental challenges, described in greater detail hereinabove, still exist for A/V content buyers to identify and purchase A/V content they are exposed to and interests them. The provision of a supplemented A/V metadata simulcaster 924 implemented within physical venues 926 not only address these issues, but extends the existing hybrid value chain model for the recording industry into an extended digitized content value chain model. In this extended value chain model, the physical venue owner 926 and the manufacturer (or provider) 924 of the supplemented A/V metadata simulcaster receive a predetermined and proportionate share of each resulting on-line A/V content sale, physical or digital, processed at the present or a later time, as a result of their respective contributions to the value chain. As in the hybrid value chain model illustrated in FIG. 9b, the affiliate marketer 918 is responsible for administering the relationships between the additional stakeholders and insuring that each participant in the value chain receive their requisite share of each on-line content sale.

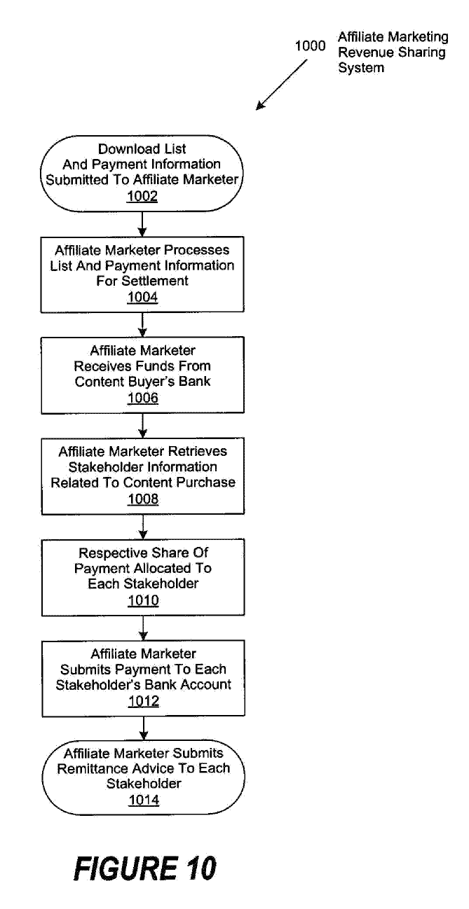

FIG. 10 is a generalized block diagram illustrates an affiliate marketing revenue sharing system 1000 for the automatic allocation of each extended value chain stakeholder's proportionate share of an on-line content purchase that originated from simulcasted metadata in accordance with an embodiment of the invention. In an embodiment of the invention, an on-line content purchaser's download list and payment instructions are submitted to an affiliate marketer for processing in step 1002. In step 1004, the affiliate marketer submits the payment instructions to a financial network for acquisition of funds from the on-line content buyers bank, which are then received in step 1006. Once funds are received from the on-line content buyer's bank in step 1006, the affiliate marketer retrieves the associated A/V content download list, the supplemented A/V content metadata that originated the on-line A/V content purchase, and other information related to stakeholder participants in the extended value chain that facilitated the on-line A/V content purchase in step 1008. The retrieved information is processed by the affiliate marketer in step 1010 and a proportionate share of the funds received from the on-line A/V content purchaser's bank is allocated to each extended digitized content value chain stakeholder and the funds are then transferred to their respective bank accounts in step 1012. Once funds are transferred in step 1012, the affiliate marketer submits remittance advice to each extended digitized content value chain stakeholder in step 1014.

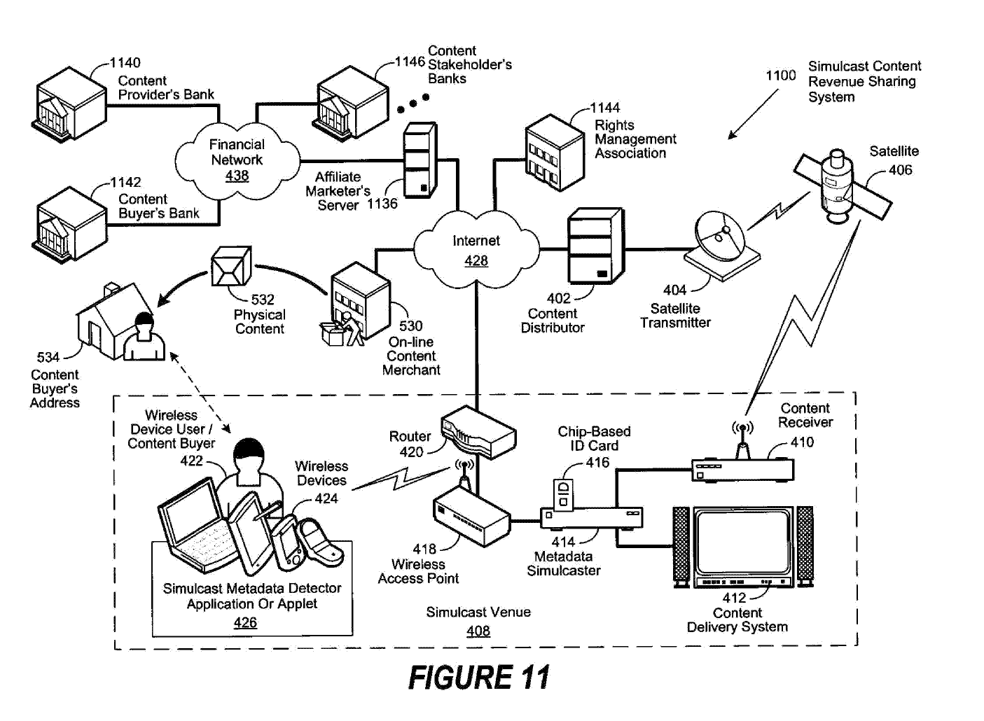

FIG. 11 is a generalized block diagram of a simulcast content revenue sharing system as implemented in accordance with an embodiment of the invention for the simulcasting of audio/video (A/V) metadata to a wireless device to enable an extended value chain that facilitates an on-line purchase of an electronic copy of the associated content. In this embodiment of the invention, simulcast digital content delivery system 400 comprises content distributor 402, coupled to the Internet 428 and satellite transmitter 404, satellite 406, and simulcast venue 408. Content distributor 402 streams predetermined A/V content with associated metadata to satellite transmitter 404, which transmits it to satellite 406 for broadcast to simulcast venue 408.

Simulcast venue 408 comprises content receiver 410, A/V content delivery system 412, A/V metadata simulcaster 414, wireless access point 418, router 420, wireless device user/content buyer 422 and wireless devices 424 implemented with metadata simulcast detector application or applet 426. In an embodiment of the invention, digitized A/V content broadcast from satellite 406 is received by content receiver 410, where it is intercepted by metadata simulcaster 414, which decouples and simulcasts metadata associated with the A/V content as it is being played by content delivery system 412. In different embodiments of the invention, decoupled metadata is time stamped and supplemental metadata is appended or substituted including, but not limited to, unique identifiers of the venue where the content is being played, serial numbers and/or unique identifiers of the digital content receiver used to receive the A/V content and the metadata simulcaster used to simulcast the supplemented metadata, Internet addresses of on-line providers of the A/V content, and special promotions.

In an embodiment of the invention, metadata simulcaster 414 comprises a chip-based identification card 416, which provides metadata origination and extended value chain stakeholder information to facilitate an on-line purchase of associated A/V content. After A/V content metadata is decoupled from the intercepted digitized A/V content stream, it is supplemented as described in greater detail hereinabove and then stored internally in metadata simulcaster 414 or on an external host for remote and/or later retrieval. Metadata simulcaster 414 then wirelessly simulcasts the processed metadata through wireless access port 418 using one or more protocols such as, but not limited to, 802.11 (WiFi), short message service (SMS), or general packet radio service (GPRS).

Wireless device users who are potential A/V content buyers 422 are notified that supplemented metadata associated with the A/V content currently being played is available through the use of wireless-enabled devices 424 including, but not limited to laptop computers, personal digital assistants (PDAs), portable media players and cell phones. In one embodiment of the invention, notification is displayed on a video screen of content delivery system 412 along with the metadata. In another embodiment of the invention, such as when content delivery system 412 only provides audio, wireless device users/content buyers 422 are notified when they access the venue's wireless access point 418 for access to the Internet 428. In another embodiment of the invention in an audio-only environment, wireless device users/content buyers 422 are notified of the availability of supplemented A/V content metadata verbally or through printed materials.

Wireless device users/content buyers 422 who decide to receive simulcasted A/V content metadata boot their wireless devices 424 to connect to the venue's wireless access point 418 at which point the wireless device user/content buyer 422 is prompted to install metadata detector application or applet 426. In one embodiment of the invention, the supplemented A/V metadata detector application or applet automatically detects and displays supplemented A/V content metadata that is simulcasted, or “pushed”, by the metadata simulcaster. In another embodiment of the invention, the metadata detector application or applet displays an advisory screen or link to “pull” the wireless device user to the metadata simulcaster, which acts as a server for providing simulcasted and/or stored A/V content metadata that has been supplemented. Once a metadata detector application or applet 426 is installed on a wireless device 424, supplemented A/V content metadata, including information facilitating an on-line purchase of the associated A/V content, is displayed on the wireless device 424 as described in greater detail hereinabove. In an embodiment of the invention, A/V content metadata displayed on wireless devices 424 includes time-stamped and supplemental metadata including, but not limited to, unique identifiers of the venue 408 where the content is being played, Internet addresses of on-line providers of the A/V content, and special promotions.

In this embodiment of the invention, the wireless device user/content buyer 422 can use the displayed A/V content metadata to facilitate the enactment of an on-line purchase of the associated A/V content. In another embodiment of the invention, other supplemental metadata such as, but not limited to, information related to stakeholders in the extended value chain that facilitates the on-line purchase of A/V content is not displayed, but is conveyed at the time of purchase to the on-line A/V content purchase site. In an embodiment of the invention, the wireless device user/content buyer 422 is given the option of using the supplemented and simulcasted A/V content metadata to facilitate purchasing a physical copy 532 of the associated A/V content from on-line content merchant 530 and having it delivered to the content buyer's physical address 534, or purchasing an electronic copy from content distributor 402, or both.

In this same embodiment of the invention, the wireless device user/content buyer 422 selects an on-line content merchant 530 displayed by the metadata detector application or applet 426 on their wireless device 424 and wirelessly connects to their on-line purchase site through wireless access point 418, which is connected to router 420, which in turn is coupled to the Internet 428. When the wireless device user/content buyer 422 connects to the on-line content merchant's site 530, the supplemented A/V content metadata stored in their wireless device 424 is presented to the on-line merchant. The wireless device user/content buyer 422 is then led through purchase and payment steps described in greater detail hereinabove to purchase a physical copy of the album containing the A/V content associated with the supplemented A/V content metadata previously presented. In an embodiment of the invention, wireless device user/content buyer 422 manually enters additional information including, but not limited to, shipping address and payment details. In another embodiment of the invention additional information including, but not limited to, shipping address and payment details are securely and automatically appended to the supplemented A/V content metadata presented by the simulcast metadata detector 426.

Once the purchase is completed, on-line content merchant 530 ships a physical copy of the associated A/V content 532 to the physical address 534 specified by the wireless device user/content buyer 422. The wireless device user/content buyer 422 then connects to content distributor 402 to conduct and complete the purchase of an electronic copy of the associated A/V content. Once the purchase is completed, the associated A/V content is downloaded through Internet 428, through router 420 and wireless access point 418, and on to wireless devices 424. In another embodiment of the invention, the wireless device user/content buyer stores purchase details including, but not limited to, name, shipping and billing addresses, phone numbers, and purchase card information, which can be automatically submitted to on-line content merchant 530 to further facilitate the purchase of associated A/V content. In another embodiment of the invention, the wireless device user/content buyer 422 downloads the selected A/V content from a content delivery site that they subscribe to, but is not included in the simulcasted and supplemented A/V content metadata. In another embodiment of the invention, if the wireless device user 422 decides not to purchase the associated A/V content at that time, the supplemented A/V content metadata is saved to the wireless device 424 facilitating a later purchase of the associated A/V content. In other embodiments of the invention, wireless device users/content buyers 422 select supplemented A/V content metadata for a single selection, an entire playlist, or a partial play list, and save the supplemented metadata to the wireless device to use as reference for a later purchase of the associated A/V content.

In an embodiment of the invention, once wireless device user/content buyer 422 has completed an on-line purchase of a physical copy of A/V content from on-line content merchant 530 for later delivery, and has completed an on-line purchase of an electronic copy of the same A/V content from on-line content distributor 402 for download at the present time, each extended value chain stakeholder's proportionate share of the on-line content purchases are automatically allocated and settled. In an embodiment of the invention, wireless device user/content purchaser's 422 download list and payment instructions are submitted via the Internet 428 to affiliate marketer 1136 for processing by on-line content merchant 530 and/or on-line content distributor 402. The affiliate marketer 1136 submits the payment instructions to a financial network 438 for acquisition of funds from the on-line content buyers bank 1142. Once funds are received from the on-line content buyer's bank 1142, the affiliate marketer 1136 retrieves the associated A/V content download list, the supplemented A/V content metadata that originated the on-line A/V content purchase, and other information related to the stakeholder participants in the extended value chain that facilitated the on-line A/V content purchases. The retrieved information is then processed by the affiliate marketer 1136 and a proportionate share of the funds received from the on-line A/V content buyer's bank 1142 is allocated to each extended value chain stakeholder and the funds are then transferred to their respective bank accounts 1146 via financial network 438. Once funds are transferred, the affiliate marketer 1136 submits remittance advice to each extended digitized content value chain stakeholder.

In an embodiment of the invention, on-line merchant 530 and/or on-line content distributor 402 forego the use of an affiliate marketer 1136 and use supplemented A/V content metadata presented at the time of on-line purchase to proportionally allocate and settle payment funds to the stakeholder participants in the extended value chain that facilitated the on-line A/V content purchases. In this embodiment, payment acquisition instructions are submitted to the on-line content buyer's bank 1142 via financial network 438, requesting that funds be transferred to the on-line content provider's bank 1140. Once received, on-line merchant 530 and/or on-line content distributor 402 retrieves and processes the associated A/V content download list, the supplemented A/V content metadata that originated the on-line A/V content purchase, and other information related to the stakeholder participants in the extended value chain that facilitated the on-line A/V content purchases. Once processed, a proportionate share of the funds is allocated to each extended value chain stakeholder and the funds are then transferred to their respective bank accounts 1146 via financial network 438. Once funds are transferred, the on-line merchant 530 and/or on-line content distributor 402 submit remittance advice to each extended digitized content value chain stakeholder. In another embodiment of the invention, affiliate marketer 1136 maintains a relationship with rights management association 1144 to act on behalf of its constituents to protect and maintain their legal and financial rights. In this embodiment of the invention, the rights management association 1144 is treated by the affiliate marketer 1136 as another stakeholder in the extended digitized content value chain, with their proportionate and requisite share of each sale processed, allocated, paid and remitted as described in greater detail hereinabove. Skilled practitioners in the art will recognize that many other embodiments and variations of the present invention are possible. In addition, each of the referenced components in this embodiment of the invention may be comprised of a plurality of components, each interacting with the other in a distributed environment. Furthermore, other embodiments of the invention may expand on the referenced embodiment to extend the scale and reach of the system's implementation.

What is claimed is:

1. A system for controlling transactions for the delivery of digital information, comprising:
a content receiver operable to receive a wirelessly transmitted digital content stream and to generate a decoded digital content data stream therefrom;
a metadata simulcaster operable to:
receive said decoded digital content data stream and extract metadata therefrom;
process said metadata to add supplemental data thereto, thereby generating supplemented metadata; and
wirelessly retransmit said supplemented metadata; and
an information handling system operable to use said metadata to process transactions comprising digital content associated with said metadata.

2. The system of claim 1, wherein said supplemented metadata is received by a wireless device.

3. The system of claim 2, wherein said supplemented metadata is stored on said simulcaster for access at a later time.

4. The system of claim 2, wherein said supplemented metadata is retransmitted by said simulcaster immediately.

5. The system of claim 2, wherein said wireless device comprises a metadata detector operable to receive said retransmitted supplemented metadata.

6. The system of claim 2, wherein said simulcaster is operable to push said retransmitted supplemented metadata and said digital content to said wireless device.

7. The system of claim 2, wherein said simulcaster is operable to pull said wireless device to said retransmitted supplemented metadata.

8. The system of claim 2, wherein said retransmitted supplemented metadata comprises a metadata tag.

9. The system of claim 8, wherein said metadata tag comprises digitized content purchase information.

10. The system of claim 8, wherein said metadata tag comprises value chain stakeholder information.

11. A method for controlling transactions for the delivery of digital information, comprising:
using a content receiver to receive a wirelessly transmitted digital content stream and to generate a decoded digital content data stream therefrom;
using a metadata simulcaster to:
receive said decoded digital content data stream and extract metadata therefrom;
process said metadata to add supplemental data thereto, thereby generating supplemented metadata; and
wirelessly retransmit said supplemented metadata; and
using an information handling system to process said metadata to process transactions comprising digital content associated with said metadata.

12. The method of claim 11, further comprising:
receiving said supplemented metadata with a wireless device.

13. The method of claim 12, further comprising:
storing said supplemented metadata on said simulcaster for access at a later time.

14. The method of claim 12, wherein said supplemented metadata is retransmitted by said simulcaster immediately.

15. The method of claim 12, wherein said wireless device comprises a metadata detector operable to receive said retransmitted supplemented metadata.

16. The method of claim 12, further comprising:
using said simulcaster to push said retransmitted supplemented metadata and said digital content to said wireless device.

17. The method of claim 12, further comprising:
using said simulcaster to pull said wireless device to said retransmitted supplemented metadata.

18. The method of claim 12, wherein said retransmitted supplemented metadata comprises a metadata tag.

19. The method of claim 18, wherein said metadata tag comprises content purchase information.

20. The method of claim 18, wherein said metadata tag comprises value chain stakeholder information.
